(19) United States
(12) Patent Application Publication
(10) Pub. No.: US 2009/0003262 A1
(43) Pub. Date: Jan. 1, 2009

(54) METHOD, SYSTEM AND DEVICE FOR SIGNALING PROCESSING IN A CDMA SYSTEM

(75) Inventor: Zhengyue CHENG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/205,738

(22) Filed: Sep. 5, 2008

Related U.S. Application Data
(63) Continuation of application No. PCT/CN2007/000488, filed on Feb. 12, 2007.

(30) Foreign Application Priority Data
Mar. 8, 2006 (CN) 200610058163.0

(51) Int. Cl. H04B 7/216

(52) U.S. Cl. 370/320

(57) ABSTRACT

A method, system and device of signaling processing in a CDMA system is provided. A switching device of a calling party sends information related to a call of the calling party to a service control point of the calling party, after the switching device detects that the calling party releases the call before a called party answers, and the service control point releases resources related to the call according to the information related to the call.

### CROSS-REFERENCE TO RELATED APPLICATION

This application is a continuation of International Patent Application No. PCT/CN2007/000488, filed Feb. 12, 2007, which claims priority to Chinese Patent Application No. 200610058163.0, filed Mar. 8, 2006, each of which is hereby incorporated by reference in its entirety.

### FIELD OF THE INVENTION

The present invention relates to communication field, and more particularly to signaling processing in a Code Division Multiple Access (CDMA) system.

### BACKGROUND

In the CDMA intelligent network (IN) service, there is a special scenario that when a pre-paid calling party makes a call to a regular called party and connects to the called mobile device, the pre-paid calling party abandons the call before the called mobile device goes off-hook to answer.

In the above special scenario, when abandoning the call, the calling party informs a Mobile Switching Center (MSC) of an originating office to release the voice channel connected to the called mobile device. If a Service Control Point (SCP) has not received any message transmitted from the MSC till the SCP Service Logic Process (SLPI) Instance times out, the SCP detects the state of the MSC. Upon detecting that there is no call related to the above one in the MSC, the SCP releases all the resources related to the call.

From the above technical solution, it can be seen that: when the calling party abandons the call, the MSC of the originating office has to check whether there is a relevant calling context in the local office while the SCP is checking the state of the MSC. This results in resource waste in the MSC. Moreover, the SCP does not release the resources until it is found that there is no call related to the above one in the MSC. This further wastes the SCP resources and influences the SCP processing speed.

### SUMMARY

Embodiments of the present invention provide a method, system and device for signaling processing in a CDMA system, each of which saves the SCP resources and improves the SCP processing speed.

An embodiment of the present invention provides a method of signaling processing in a Code Division Multiple Access (CDMA) system. The method comprises:

sending, by a switching device of a calling party, information related to a call of the calling party to a service control point of the calling party after the switching device of the calling party detects that the calling party releases the call before a called party answers to the call;

releasing, by the service control point, resources related to the call according to the information related to the call.

An embodiment of the present invention provides a CDMA-based signaling processing system. The system comprises a switching device and a service control point; wherein,

the switching device is adapted to send information related to a call of a calling party to the service control point of the calling party according to received information after the switching device detects that the calling party releases the call before a called party answers to the call; and

the service control point is adapted to release resources related to the call of the calling party according to the information related to the call.

An embodiment of the present invention provides a switching device. The switching device comprises a determination module and a sending module; wherein,

the determination module is adapted to send a notification to the sending module, upon determining that a calling party releases a call before a called party answers according to received information; and

the sending module is adapted to send information related to the call to a service control point of the calling party, upon receiving the notification from the determination module.

An embodiment of the present invention provides a service control point. The service control point comprises a receiving and parsing module, a detection module and a resource management module; wherein,

the receiving and parsing module is adapted to receive information related to a call sent from a switching device and parse the received information;

the detection module is adapted to inform the resource management module, upon detecting that the information parsed by the receiving and parsing module comprises information related to a call of calling party being released before a called party answers to the call; and

the resource management module is adapted to release resources related to the call of the calling party according to the parsed information.

From the technical solutions provided in the above embodiments, it can be seen that: when a calling party releases a call before the called party is off-hook, the information regarding the fact that the calling party releases the call may be sent to the SCP in the intelligent network. Thus, the SCP can obtain the information regarding the calling party releasing the call in time, and release the resources timely according to the received information. As a result, the SCP resources may be saved and the SCP processing speed may be improved.

### BRIEF DESCRIPTION OF THE DRAWINGS

FIG. 1 is a first flow chart of a signaling processing method according to an embodiment of the invention; and

FIG. 2 is a second flow chart of a signaling processing method according to an embodiment of the invention.

FIG. 3 simply illustrates a signaling processing system according to an embodiment of the invention.

FIG. 4 simply illustrates a switching device according to an embodiment of the invention.

FIG. 5 simply illustrates a service control point according to an embodiment of the invention.

### DETAILED DESCRIPTION

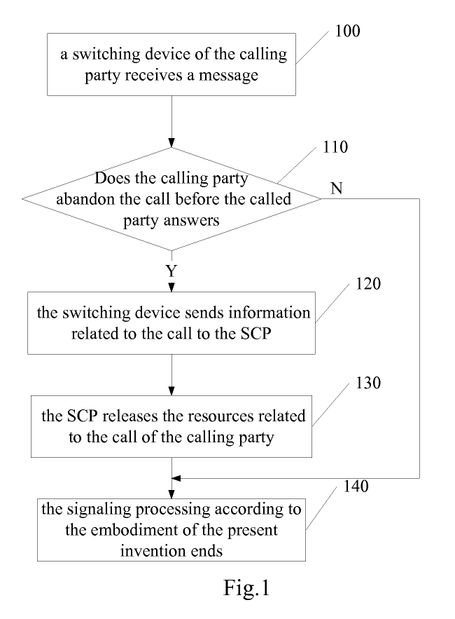

FIG. 1 illustrates a technical solution for signaling processing according to the first embodiment of the present invention.

As shown in FIG. 1, a switching device, such as an MSC, of the calling party receives a message at block 100.

In block 110, according to the received message, the switching device determines whether the calling party abandons the call before the called party answers the call. If it is determined that the calling party abandons the call before the called party answers, the procedure proceeds to block 120; otherwise, the procedure proceeds to block 140.

In block 120, the switching device reports the information related to the call to an SCP of the calling party on its own initiative, so as to inform the SCP that the calling party has abandoned the call. In this step, the MSC of the calling party may use an ODISCONNECT (an origination disconnected invoke) message to carry the information related to the call, and report the message to the SCP of the calling party.

In block 130, the SCP of the calling party receives and parses the ODISCONNECT message, and releases all resources related to the call according to the information related to the call and parsed from the message.

In block 140, the signaling processing according to the embodiment of the present invention ends.

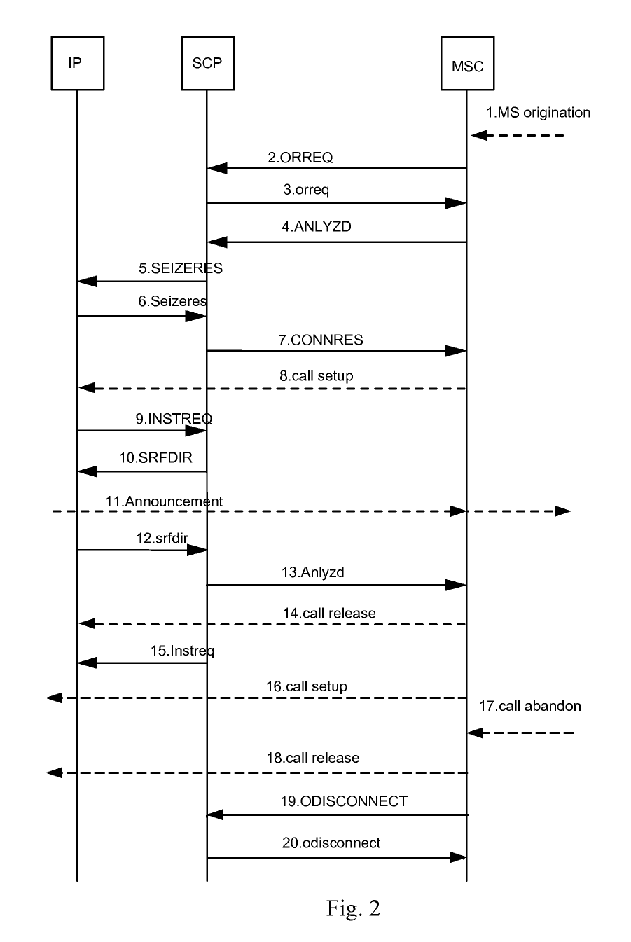

In the following, the signaling flow in the above technical solution is described by taking the MSC as an example with reference to FIG. 2.

In FIG. 2, at step 1, the calling party originates a call at an originating office. The MSC of the originating office receives the called number that the calling party dialed.

At step 2, the MSC of the originating office checks whether an Origination_Attempt_Authorized trigger satisfies a triggering condition. When the trigger satisfies the triggering condition, an ORREQ (an origination request invoke) message is sent to the SCP (Service Control Point).

At step 3, after the SCP confirms that the calling party has enough balance and authorization, the call is allowed to continue, and the SCP returns an orreq (an origination request return result) message to the MSC of the originating office, so as to inform the MSC of the originating office to continue processing the current call. The parameter DMH_SVCID in this message is used for informing the originating office that the current call is an IN PPS (pre-paid service) call.

At step 4, the MSC of the originating office analyzes the called number that the calling party dialed, and then prepares the routing. Then the MSC triggers a Calling_Routing_Address_Available trigger and sends an ANLYZD (analyzed information) message to the SCP.

At step 5, after the SCP finds that a balance announcement is required to be made to the calling party through checking, the SCP sends a SEIZERES message (a seize resource invoke message) to an Intelligent Peripheral (IP) for requesting a resource to make the announcement.

At step 6, upon receiving the SEIZERES message, the IP allocates a resource for the announcement and returns to the SCP a seizeres message (a seize resource return result message) with a Temporary Local Directory Number (TLDN) corresponding to the allocated resource.

At step 7, the SCP sends a CONNRES (a connection resource request) message to the MSC of the originating office, in order to request the MSC to be connected with a voice channel of the IP.

At step 8, the MSC sends a call setup request (for setting up a voice channel) to the IP, so as to request a voice channel connected to the IP.

At step 9, upon finding that the voice channel for the announcement is connected, the IP sends an INSTREQ (an announcement instruction request) message to the SCP, to request an announcement instruction.

At step 10, the SCP sends a SRFDIR (SRF Directive) message to the IP and instructs the IP to make the announcement via the parameter ANNLIST (announcement list).

At step 11, the IP makes the announcement to the user according to the ANNLIST.

At step 12, when the announcement is finished, the IP returns an empty srfdir (the SRF Directive response) message to the SCP.

At step 13, the SCP returns an anlyzd (analyzed information response) message to the MSC of the originating office.

At step 14, the MSC of the originating office releases the voice channel connected to the IP.

At step 15, the SCP sends an instreq (instruction request response) message to the IP and ends the message transaction between the SCP and the IP.

At step 16, the MSC of the originating office is connected with the voice channel of the called office by using a call setup message, and the called party rings.

At step 17, in the case that the called party does not answer, the calling party abandons the call and sends a call abandon message to the MSC of the originating office.

At step 18, the MSC of the originating office sends a call release message to the called mobile device to release the voice channel connected to the called mobile device.

At step 19, after releasing the voice channel, the MSC of the originating office reports the ODISCONNECT message to the SCP on its own initiative. The ODISCONNECT message carries the following parameters:

a. Trigtype (Trigger type), for indicating the trigger that the ODISCONNECT message sent by the originating office detects. If the detected trigger is an ODISCCONT trigger, the value of Trigtype is defined as 41.

b. MSCID of the MSC of the originating office, for identifying the MSC of the originating office for the calling party. For example, when a subscriber makes a call whiling roaming, the MSCID may be the MSCID of the MSC at the caller's roaming area.

c. BillingID, a parameter for uniquely identifying the current call. The BillingID may be filled with actual BillingID information of the call, and be consistent with the billing that is obtained in previous operations of the call. Thus, when the SCP receives this parameter, the corresponding call automaton on the SCP may be identified.

d. MSID of the calling party (a unique identifier of the calling mobile device), for identifying the calling mobile device. The MSID may be filled with MSID information of the real calling mobile device.

e. MDN of the calling party (the calling mobile device number), for correctly identifying the calling party when the SCP performs the call control and billing processing. The MDN can be filled with a real number of a mobile device that the calling party uses.

f. ReleaseCause (the reason for releasing a given call), for describing the reason of call failure. In an embodiment of the present invention, the parameter ReleaseCause may be as shown in Table 1.

TABLE 1

| 1 octet | | | | | | | | |
|---|---|---|---|---|---|---|---|---|
| H | G | F | E | D | C | B | A | Value Meaning |
| 0 | 0 | 0 | 0 | 0 | 0 | 0 | 0 | Unspecified |
| 0 | 0 | 0 | 0 | 0 | 0 | 0 | 1 | Calling Party. |
| 0 | 0 | 0 | 0 | 0 | 0 | 1 | 0 | Called Party. |
| 0 | 0 | 0 | 0 | 0 | 0 | 1 | 1 | Commanded Disconnect. |

Table 1 shows that, when all the bits of the 8 bit byte are zeroes, it indicates that the ReleaseCause is unspecified. When the last bit of the 8 bit byte is 1 while the rest bits are zeroes, it indicates that the calling party releases the call. When the last two bits of the 8 bit byte are 1 and 0 respectively while the rest bits are zeroes, it indicates that the called party releases the call. When the last two bits of the 8 bit byte are both 1 while the rest bits are zeroes, it indicates that it is Commanded Disconnect.

At step 20, upon receiving the ODISCONNECT message, the SCP releases all the system resources related to the call according to information carried in the ODISCONNECT message and then the SLPI ends. In the mean time, the SCP also returns an odisconnect message to inform the originate office at the calling party to clear all contexts related to the call

In step 20, upon receiving the ODISCONNECT message, the SCP searches for a call automaton corresponding to the parameter Billing ID carried in the message. By identifying the TRIGTYPE and the value of “commanded disconnect” field in the ‘ReleaseCause’, the SCP determines it is necessary to release the call. Before releasing the resources, the SCP writes a log file for the failure according to the received MSCID, MSID and MDN. After that, all the resources related to the call on the SCP (including the system resources taken by the transaction primitive processing part, the call automaton processing part and the like) are then released, and the odisconnect message is returned to the MSC.

The above embodiment describes the processing procedure that the calling party releases the call before the called party is off-hook to answer. When the calling party moves out of the service covering area of a cell, a call failure may occur due to failing to receive network signals. For this unusual situation, as long as the MSC knows that the calling party has already released the call, the SCP may be informed of this situation by receiving the ODISCONNECT message which is initiatively reported by the MSC at the calling party, and the SCP may deal with the resources related to the calling party in good time.

The above embodiments of the present invention may indicate that the MSC in these embodiments reports the ODISCONNECT message to the SCP on its own initiative, when detecting the calling party has abandoned the call, and thus this message may arrive at the SCP before an Oanswer message arrives. Upon receiving the special ODISCONNECT message, the SCP identifies and processes the message, and returns the odisconnect message to the MSC. These embodiments of the present invention optimize the procedure of the PPS calling party abandoning the call in the IN, and therefore, avoid the passive waiting by the SCP and the call contexts searching by the MSC, which saves the resources in both the MSC and the SCP, and improves the processing efficiency of the SCP.

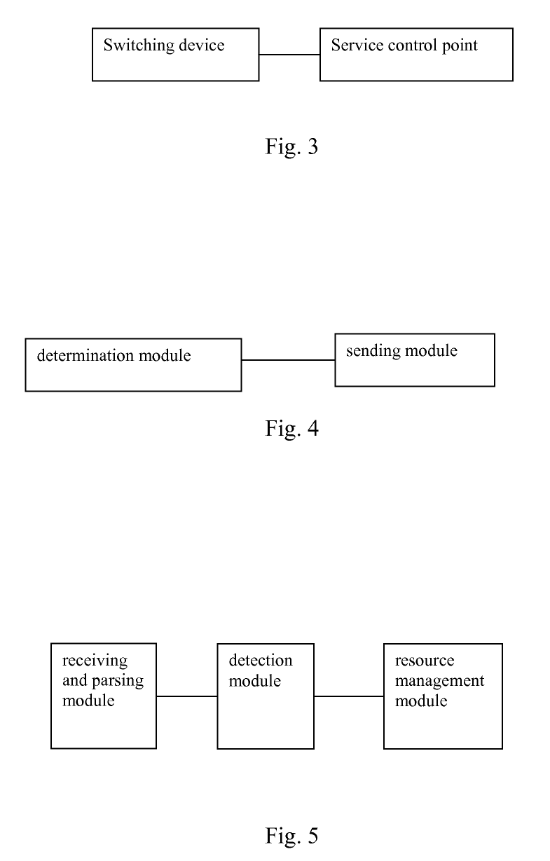

Another embodiment of the present invention provides a signaling processing system, as shown in the FIG. 3, which includes a switching device and an SCP. In the following, the system according to the embodiment of the present invention will be described by taking an example, in which the MSC is selected as the switching device.

In the case that the calling party makes a call to the called party, if, according to the received information such as a call abandon message, the MSC finds that the calling party abandons the call due to no signal, on-hook and the like before the called party answers, the MSC will report an ODISCONNECT message to the SCP on its own initiative after releasing the voice channel connected to the called mobile device. The ODISCONNECT message carries the following parameters: Trigtype, MSCID of the MSC of the originating office, BillingID, MSID of the calling party, MDN of the call party, ReleaseCause, etc.

Upon receiving the ODISCONNECT message, the SCP searches for a call automaton corresponding to the parameter Billing ID carried in the message. By identifying the TRIGTYPE and the value of “commanded disconnect” in ‘release cause’, the SCP determines it is necessary to release the call. Before releasing all the resources related to the call on the SCP, the SCP writes a log file for the failure according to the received MSCID, MSID and MDN. Then, all of the resources related to the call automaton are released. The resources related to the call automaton include, for example, the system resources taken by the transaction primitive processing part, the call automaton processing part and the like. The SCP then returns the odisconnect message to the MSC, so as to inform the MSC to clear the contexts related to the call.

Another embodiment of the present invention provides a switching device such as an MSC. As shown in the FIG. 4, a determination module and a sending module are arranged in the switching device.

The determination module is adapted to send a notification to the sending module upon knowing that the calling party releases the call. The reason for the calling party to release the call may be that, for example, the calling party abandons the call due to no signal or on-hook, before the called party answers. The determination module can decide that the calling party releases the call before the called party is answers, according to information such as a call abandon message received by a switching device.

Upon receiving the notification from the determination module, the sending module reports all information related to the call to the SCP of the calling party. For example, the sending module reports an ODISCONNECT message to the SCP on its own initiative, after its MSC releases the voice channel connected to the called mobile device. The ODISCONNECT message carries the following parameters: Trigtype, MSCID of the MSC of the originating office, BillingID, MSID of the calling party, MDN of the call party, ReleaseCause etc. Billing ID in the ODISCONNECT message can be used by the SCP to search for the corresponding call automaton. TRIGTYPE and the value of “commanded disconnect” in ReleaseCause in the ODISCONNECT message can be used by the SCP to determine that the call needs to be released. MSCID, MSID and MDN in the ODISCONNECT message can be used by the SCP to write a log file for the failure. Upon receiving the odisconnect message returned from the SCP, the MSC of the embodiment of the present invention clears the contexts related to the call, according to information contained in the odisconnect message.

An embodiment of the present invention further provides a service control point. The service control point comprises a receiving and parsing module, a detection module and a resource management module as shown in the FIG. 5.

The receiving and parsing module is adapted to receive information sent from a switching device and parse the received information. For example, the receiving and parsing module receives an ODISCONNECT message sent from the switching device and parses the ODISCONNECT message to obtain parameters such as Trigtype, MSCID of the MSC of the originating office, BillingID, MSID of the calling party, MDN of the call party, ReleaseCause and etc.

The detection module is mainly adapted to detect information parsed by the receiving and parsing module, so as to determine whether information parsed by the receiving and parsing module includes information related to the event that “the calling party releases the call before the called party answers”. For example, by identifying the passed TRIGTYPE and the value of “command disconnect” in “ReleaseCause”, the detection module determines that the call is required to be released, and notifies the resource management module.

Upon receiving the notification from the detection module, the resource management module searches for the call automaton corresponding to the parameter Billing ID contained in the parsed information. Then, all the resources related to the call on the SCP are released. The resources related to the call include, for example, the system resources taken by the transaction primitive processing part, the call automaton processing part and the like.

The SCP of the embodiment of the present invention may also write a log file for the failure according to the parsed MSCID, MSID and MDN. The SCP also is required to return an odisconnect message to the MSC, so as to inform the MSC to clear the context related to the call.

The above is preferred embodiments of the disclosure, and is not intended to limit the scope of the disclosure. For example, the calling party in the present invention is not limited to pre-paid subscribers. Any modification, equivalent substitution and improvement within the spirit and scope of the disclosure are intended to be included in the scope of the disclosure.

What is claimed is:

1. A method of signaling processing in a Code Division Multiple Access (CDMA) system, comprising:
sending, by a switching device of a calling party, information related to a call of the calling party to a service control point of the calling party after the switching device of the calling party detects that the calling party releases the call before a called party answers to the call;
releasing, by the service control point, resources related to the call according to the information related to the call.

2. The method of claim 1, wherein the information related to the call is carried in an ODISCONNECT message, and the ODISCONNECT message is sent from the switching device of the calling party to the service control point of the calling party.

3. The method of claim 1, wherein the information related to the call includes following parameters: Trigger type (Trigtype), Billing ID of the call (BillingID), and reasons for releasing the call (ReleaseCause);
the releasing resources related to the call of the calling party according to the information related to the call comprising:
searching, by the service control point, a corresponding call automaton according to the parameter BillingID;
releasing resources related to the call automaton on the service control point, when the service control point determines that the call is to be released according to the parameter Trigtype and a value of the parameter ReleaseCause.

4. The method of claim 3, wherein the information related to the call further comprises at least one of following parameters: an MSC identification (MSCID) of an MSC for a mobile device of the calling party, a mobile device identification (MSID) of the calling party, and a mobile device number (MDN) of the calling party; and the method further comprises:
writing, by the service control point, a log file for failure according to the received MSCID, MSID and MDN.

5. The method of claim 1, further comprising:
sending, by the service control point, a response message to inform the originating office to clear all contexts related to the call, after the service control point releases the resources related to the call according to the information related to the call.

6. The method of claim 5, wherein the response message comprises an odisconnect response message.

7. A CDMA-based signaling processing system, comprising a switching device and a service control point; wherein
the switching device is adapted to send information related to a call of a calling party to the service control point of the calling party according to received information after the switching device detects that the calling party releases the call before a called party answers to the call; and
the service control point is adapted to release resources related to the call of the calling party according to the information related to the call.

8. The system of claim 7, wherein the service control point is adapted to search for a corresponding call automaton according to a Billing identification (Billing ID) of the call in the received information related to the call, and release the resources related to the searched call automaton when it is determined that the call is to be released according to the trigger type and the reasons for releasing the call, both of which is included in the received information related to the call.

9. A switching device, comprising a determination module and a sending module, wherein,
the determination module is adapted to send a notification to the sending module, upon determining that a calling party releases a call before a called party answers according to received information; and
the sending module is adapted to send information related to the call to a service control point of the calling party, upon receiving the notification from the determination module.

10. A service control point, comprising a receiving and parsing module, a detection module and a resource management module, wherein,
the receiving and parsing module is adapted to receive information related to a call sent from a switching device and parse the received information;
the detection module is adapted to inform the resource management module, upon detecting that the information parsed by the receiving and parsing module comprises information related to a call of calling party being released before a called party answers to the call; and
the resource management module is adapted to release resources related to the call of the calling party according to the parsed information.
